(19) United States
(12) Patent Application Publication
(10) Pub. No.: US 2025/0179789 A1
(43) Pub. Date: Jun. 5, 2025

(54) DRAINAGE PIPE COVERS WITH DATA PATTERNS PROVIDED THEREON

(71) Applicant: Guardian Sensor Technologies Inc., Etobicoke (CA)

(72) Inventor: John Petrachek, Etobicoke (CA)

(73) Assignee: Guardian Sensor Technologies Inc., Etobicoke (CA)

(21) Appl. No.: 18/965,009

(22) Filed: Dec. 2, 2024

Related U.S. Application Data
(60) Provisional application No. 63/604,582, filed on Nov. 30, 2023.

(51) Int. Cl. E03F 7/00; G06K 19/06; G06Q 10/20

(52) U.S. Cl. CPC E03F 7/00; G06K 19/06037; G06Q 10/20

(57) ABSTRACT

A cover for a drainage pipe comprising a machine-readable data pattern provided on the cover, the machine-readable data pattern being linked to a resource displaying building information. A building information system comprising a cover for a drainage pipe located within a perimeter of a building; a machine-readable data pattern on the cover, the machine-readable data pattern being linked to a resource displaying building information; and a database for storing the resource, the database providing the resource in response to the machine-readable data pattern being scanned.

### CROSS-REFERENCE TO RELATED APPLICATIONS

This application claims the benefit of U.S. Provisional Patent Application No. 63/604,582, filed on Nov. 30, 2023. The entire contents of U.S. Provisional Patent Application No. 63/604,582 are hereby incorporated by reference for all purposes

### TECHNICAL FIELD

The disclosure relates to covers for drainage pipes with data patterns, particularly quick response (QR) codes, provided thereon.

### INTRODUCTION

Delivering information efficiently and reliably to workers on a jobsite is critical for facilitating quality maintenance. Upon entering a jobsite, workers must orient themselves with the layout of the facility to determine where maintenance is required. To this end, workers may need to refer to building schematics or ask employees of the facility for directions. However, in some cases, this information may not be readily available or may not be where the worker expects to find it, leading to inefficiencies in the maintenance process. There is a need for an intuitive system for providing organized storage, retrieval, and dissemination of building information, ensuring that workers have access to information required for them to complete their job expediently.

U.S. Pat. No. 9,805,133 purports to disclose systems and methods for a portable communications device and a product exchanging direct commands or requests via bar codes to address a condition of the product. Some methods can include the portable communications device scanning a bar code displayed on the product and generating and displaying a bar code to be scanned by the product, wherein the bar codes represent direct commands or requests to be executed by the portable communications device or the product to address the condition of the product. Additionally, or alternatively, some methods can include the product scanning a bar code displayed on the portable communications device and generating and displaying a bar code to be scanned by the portable communications device, wherein the bar codes represent direct commands or requests to be executed by the product or the portable communications device to address the condition of the product.

PCT Patent Publication No. US2022/021268 purports to disclose a machine-readable code that can be provided on a container such as a vial. The machine-readable code includes a specific code representing a specific instance of a product contained by the container and includes a link to access to information associated with the specific instance of the product. The machine-readable code, responsive to being scanned, can be configured to cause a machine scanning the machine-readable code to automatically navigate to a web site page, allowing a user to register and track data associated with the specific instance of the product.

U.S. Pat. No. 10,789,440 purports to disclose a process of providing user information for a mechanical hand labeler to instruct the user on proper use of the device and how to reorder consumables. The mechanical hand labeler would comprise a Quick Response (QR) code that is embedded with Uniform Resource Locators (URLs) for different functions. The embedded URLs in the QR code are read via a smart phone. The smart phone reads the QR code and launches the appropriate website. Specifically, the QR code is placed on an outside of the mechanical hand labeler for providing instructions on loading supplies into the mechanical hand labeler; and the QR code is placed on an inside of the mechanical hand labeler for providing instructions on reordering supplies.

### SUMMARY

In a first aspect, some embodiments of the invention provide a cover for a drainage pipe including a machine-readable data pattern provided on the cover, the machine-readable data pattern linked to a resource displaying building information.

In some embodiments, the machine-readable data pattern includes a visual imprint.

In some embodiments, the visual imprint includes a quick response (QR) code, a barcode, and a universal product code.

In some embodiments, the machine-readable data pattern is waterproof, weather-resistant, and UV-resistant.

In some embodiments, the resource includes a web page, a document, and an image.

In some embodiments, the resource is editable.

In some embodiments, the building information includes a floor plan, a drainage

system schematic, and maintenance history.

In another aspect, some embodiments of the invention provide a building information system, including a cover for a drainage pipe located within a perimeter of a building, a machine-readable data pattern on the cover, the machine-readable data pattern linked to a resource displaying building information, and a database for storing the resource, the database providing the resource in response to the machine-readable data pattern being scanned.

In some embodiments, providing the resource includes displaying the resource on a user device.

In some embodiments, the resource is a web page, a document, and an image.

In some embodiments, the resource is editable.

In some embodiments, the database is dynamically updated in response to the machine-readable data pattern being scanned.

In some embodiments, dynamically updating the database further includes uploading an edit via a network.

In some embodiments, the edit includes a text, an image, and a document.

In some embodiments, dynamically updating the database includes recording a time when the machine-readable data pattern is scanned.

In some embodiments, the machine-readable data pattern includes a visual imprint.

In some embodiments, the visual imprint includes a quick response (QR) code, a barcode, and a universal product code.

In some embodiments, the system includes at least two covers located within the perimeter of the building, each having machine-readable data patterns, and at least two resources displaying building information, each resource being linked to the machine-readable data patterns.

In some embodiments, the at least two resources display identical building information.

In some embodiments, the at least two resources display different building information.

### BRIEF DESCRIPTION OF THE DRAWINGS

The drawings included herewith are for illustrating various examples of apparatus and systems of the present specification. In the drawings:

FIG. 1 is a top view of a cover, according to an embodiment;

FIG. 2 is a side view of the cover of FIG. 1;

FIG. 3 is an illustration of a resource, according to an embodiment;

FIG. 4 is an illustration of scanning a machine-readable data pattern on a cover, according to an embodiment; and

FIG. 5 is a schematic diagram of a system for providing building information.

### DETAILED DESCRIPTION OF VARIOUS EMBODIMENTS

Various apparatus or systems will be described below to provide an example of each claimed embodiment. No embodiment described below limits any claimed embodiment and any claimed embodiment may cover apparatus or systems that differ from those described below. The claimed embodiments are not limited to apparatus or systems having all of the features of any one apparatus or system described below or to features common to multiple or all of the apparatus or systems described below.

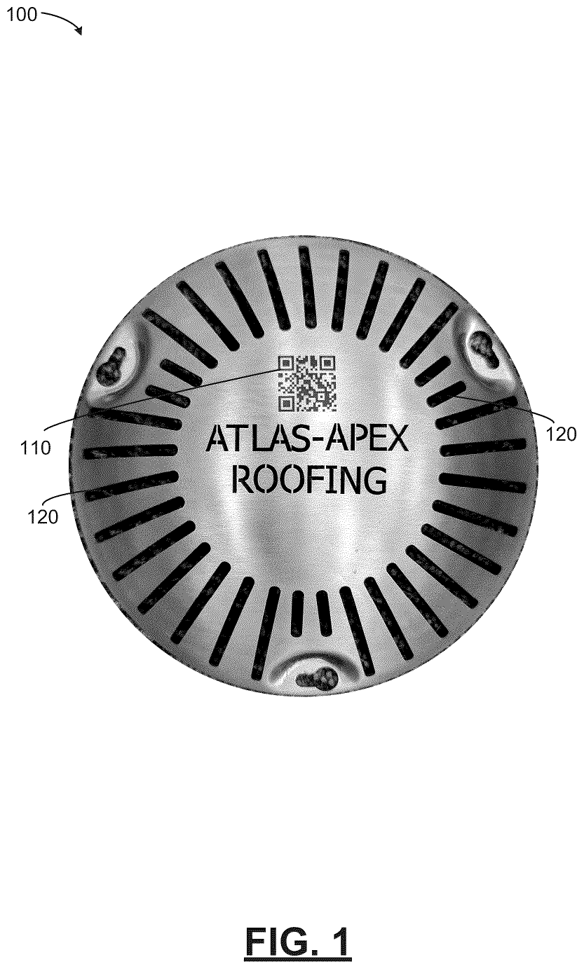

Referring to FIG. 1, a top view of an exemplary cover 100 includes a machine-readable data pattern 110 and a plurality of perforations 120 extending radially from the center of the cover 100. Each perforation 120 allows liquids to pass through the cover 100 while preventing large objects such as debris and/or small animals from entering the drainage pipe. In the illustrated example, the data pattern 110 is located near the center of the cover 100 and is provided in an area on the cover 100 that is away from the perforations 120. In some embodiments, the data pattern 110 is a visual imprint such as a quick response (QR) code.

In the illustrated example, the data pattern 110 is laser printed on the cover 100. However, any suitable means may be used to provide the data pattern 110 on the cover 100, such as but not limited to electrostatic printing, photochemical machining, or rotary engraving. In some examples, the data pattern 110 is provided on the cover 100 during manufacturing. In other words, in some examples, the cover 100 and the data pattern 110 are of unitary construction.

In some examples, data pattern 110 is not provided directly on the cover 100, but attached to the cover 100, for example, via a string looped through a perforation 120 and tied around a laminated sheet with the data pattern 110 printed thereon.

In some embodiments, the data pattern 110 is a visual imprint. Examples of visual imprints include but are not limited to QR codes, barcodes, or universal product codes (UPCs). In some examples, the data pattern 110 does not contain any distinctive black and white elements. Instead, the contrast differences between the various elements of the data pattern 110 are sufficient for scanning.

In some embodiments, the data pattern 110 is waterproof, weather-resistant and UV-resistant. For example, the data pattern 110 may be located on a roof of a building. The data pattern 110 may be exposed to forces that may degrade or morph the data pattern 110 such as inclement weather, prolonged sun exposure, and curious animals. Further, during the operation of the cover 100, liquids may submerge or flow over the data pattern 110. The liquid may be mixed with chemicals or carry debris that may fade or chip the data pattern 110. Accordingly, the data pattern 110 is manufactured for longevity via means such as electrostatic printing, photochemical machining, or rotary engraving to retain its scannable properties.

In the illustrated example, only one data pattern 110 is shown on the cover 100. However, it is understood that any number of data patterns 110 may be provided on the cover 100.

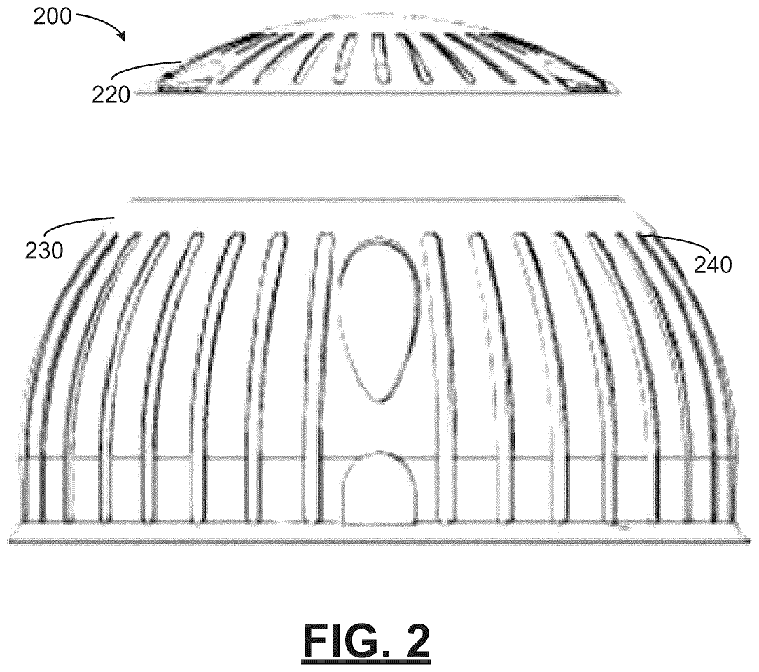

Referring to FIG. 2, a side view of the cover 200. In the illustrated example, the cover 200 has a dome-like shape. The perforations 220 follow the curve of the cover 200. The data pattern (not shown) also follows the curve of the of the cover 200 but the data pattern is positioned in an area on the cover 200 to retain its scannable properties. That is, the data pattern is positioned away from the perforations 220 to avoid interference while scanning.

In the illustrated example, the cover 200 is optionally attached to an additional component 230. The additional component 230 also follows the curve of the cover 200 and provides additional perforations 240 to enable a greater volume of liquid to flow through the cover 200 while still blocking larger objects such as debris and/or small animals from entering the drainage pipe.

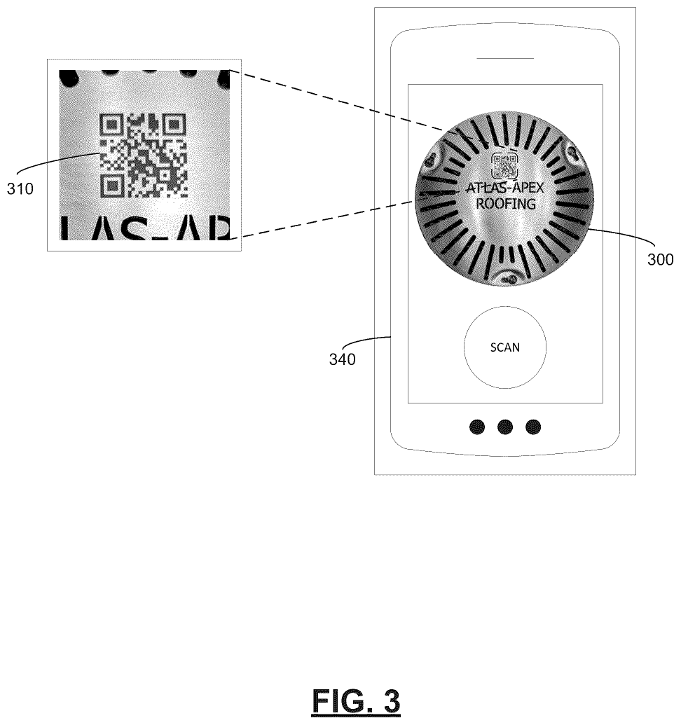

Referring to FIG. 3, a user device 340 is shown scanning the data pattern 310 using a mobile application. The user device 340 may be, using non-limiting examples, a smartphone, a laptop, a tablet, or a wearable device. The user device 340 includes a mobile application that scans the data pattern 310. In some examples, the mobile application is a proprietary application and may include a user interface (UI). In other examples, the mobile application is an application native to the user device 340 and processes the data pattern 310 using built in features of the user device 340 such as a camera or a scanner.

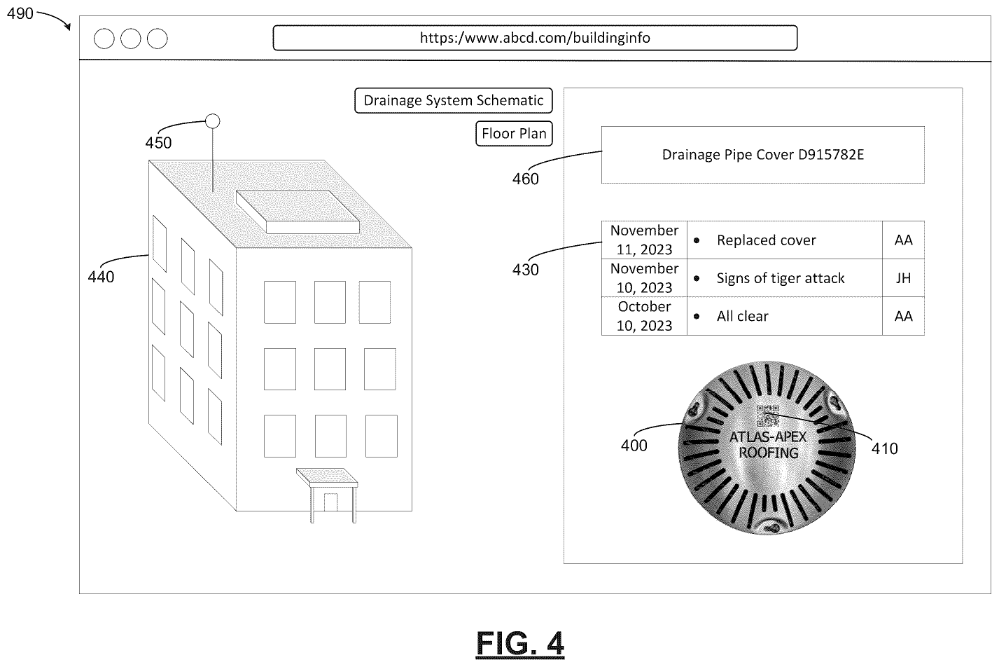

In the illustrated example, the data pattern 310 is linked to a resource (not shown but described below with reference to FIG. 4) which displays building information on the user device 340 in response to the data pattern 310 being scanned. The resource provides workers with critical information about the facility to facilitate efficient maintenance.

In some embodiments, the resource is a webpage, a document, or an image displaying building information such as, but not limited to, a floor plan, a drainage system schematic, maintenance history, or any combination of these. In some examples, the resource includes a UI which allows multiple types of building information to be displayed simultaneously.

For example, the resource may display a floor plan that includes building information relevant to a specific floor or area of a building. In other examples, the floor plan may include building information relevant to the entire building such as the location of emergency exits, elevators, and stairwells.

Alternatively, or in addition, the resource may display a drainage system schematic that includes information about the locations of other covers 300 located within a perimeter of the building. The drainage system may further include information about piping networks, valves, or drainage outlets.

Alternatively, or in addition, the resource may display maintenance history that includes information relevant to the cover 300 that is associated with the specific data pattern 310 that is scanned. For example, the resource may display a record of time entries when the data pattern 310 was scanned. In some examples, the resource may, in response to being accessed, automatically record a time entry when the data pattern 310 is scanned. The maintenance history may also display information such as maintenance instructions for the cover 300, whether there were any notable issues when maintenance was last performed on the cover 300, or a recommendation for when maintenance on the cover 300 should occur next.

In some embodiments, the resource may be editable. Workers that perform maintenance on the cover 300 may add notes to the resource that may be relevant and helpful for the next worker scheduled to perform maintenance on the cover 300. For example, the worker may record damage to the cover 300 by leaving a description or uploading an image of the damaged cover 300.

In some examples, the resource may be accessed and edited without scanning the data pattern 310. For example, the resource may be a webpage or a document that may be edited by the owner of the resource from a remote location.

In some examples, a floor plan may be edited to include structural changes to a building that may have occurred since the last time the data pattern 310 was scanned. Edits to a floor plan may include new wings of the building that were recently constructed or may display emergency exits and stairwells that may be currently closed due to construction.

In some examples, a drainage system schematic may be edited to include or remove piping connections that may have been added to or subtracted from the drainage system or may display damaged piping connections that are directly connected to the cover 300 associated with the data pattern 310 being scanned.

In some examples, the maintenance history may be edited, automatically or manually, to record a time when the data pattern 310 is scanned, to include notes about any issues that were encountered during maintenance, or to abide with a compliance feature requiring workers performing maintenance on the cover 300 to upload a picture of the cover 300 to show that maintenance was in fact performed on the cover 300 associated with the data pattern 310 that was scanned.

Referring to FIG. 4, an example embodiment of a resource 490 displaying building information. In the example illustration, the resource 490 is a webpage showing an image of a cover 400 associated with a data pattern 410. The resource 490 may display an identifier (ID) 460 associated with the data pattern 410. As described above, in some examples, the resource 490 may be editable. For example, the image of the cover 400 shown in resource 490 may be updated with photos taken by a worker on a recent maintenance visit.

In the example illustration, the resource 490 also shows maintenance history 430 associated with the cover 400. When the cover 400 is inspected, and workers scan the data pattern 410, workers may leave notes describing their visit and manually record a time when the maintenance visit occurred. In the illustrated example, two different workers visit a building 440 to perform maintenance on the cover 400, located in an area 450 on the roof of the building 440. Both workers leave notes in the maintenance history 430 log detailing their maintenance visits.

In the example illustration, the resource 490 also displays a perspective view of a building 440 within which a drainage pipe cover 400 is located. The perspective view of the building 440 also displays the location 450 of the cover 400 within the perimeter of the building. In the example illustration, the cover is located on the roof of the building 440.

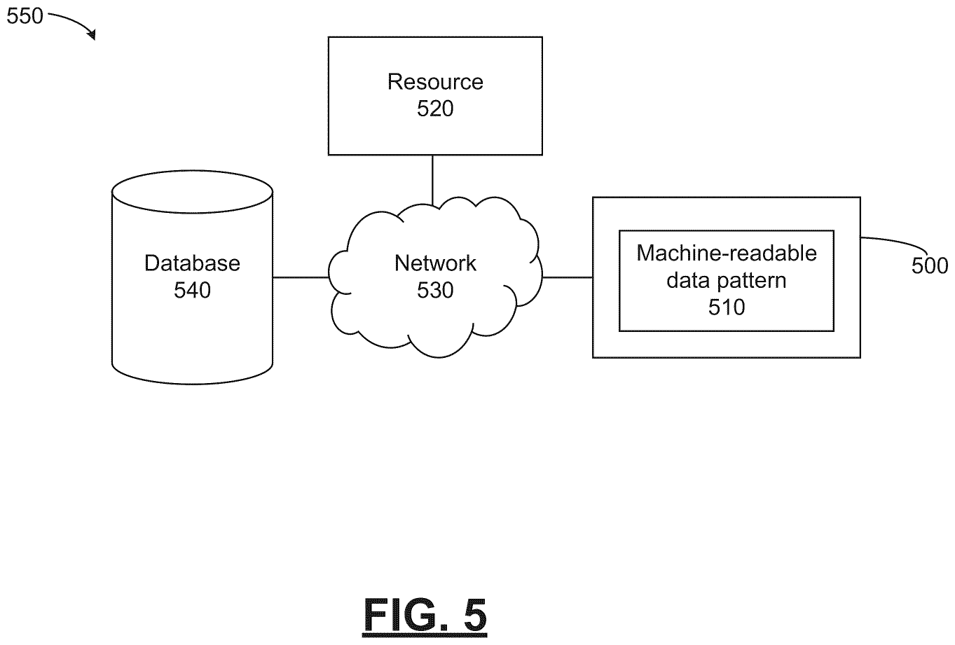

Referring to FIG. 5, a system overview for a building information system. The system 550 includes a cover 500 for a drainage pipe, a data pattern 510, and a database 540 for storing a resource 520. The database 540 provides the resource 520 in response to the data pattern 510 being scanned via a network 530.

In some examples, the database 540 may be a memory. The memory may include random access memory (RAM), read only memory (ROM), or similar types of memory. Also, in some examples, some or all of the memory may be integrated with a computer processor (not shown). For example, the computer processor may be a microcontroller (e.g., Microchip™ AVR, Microchip™ PIC, or ARM™ microcontroller) with onboard volatile and/or non-volatile memory. In such embodiments, the memory may store one or more applications for execution by the computer processor. Applications correspond with software modules including computer executable instructions to perform processing of functions and methods.

The components of the system 550 may be connected to the network 530 via a wired or wireless connection to the Internet or to a private network. In some cases, the network 530 includes other types of computer or telecommunications networks.

In some embodiments, providing the resource 520 includes displaying the resource 520 on a user device (not shown) as described above with reference to FIG. 3.

In some embodiments, the resource 520 is editable. Editing the resource dynamically updates the database 540. For example, in some embodiments, a worker may scan the data pattern 510 and the database 540 may automatically record a time when the data pattern 510 was scanned. Alternatively, or in addition, a worker may upload an edit to the resource 520 via the network 530 thereby dynamically updating the database 540. The edit may include a text, an image, or a document. As described above with reference to FIG. 4, the edit may be a new photo of the cover 500 uploaded by a worker on a recent maintenance visit.

In some embodiments, the system 550 further includes at least two covers 500 located within the perimeter of the building, each cover having a data pattern 510 provided thereon. The system 550 may further include at least two resources 520 displaying building information.

In some embodiments, the data pattern 510 for each cover 500 is unique. In other words, the data pattern 510 on each cover 500 is specific to the cover 500 that it is provided on, and each data pattern 510 is linked to a unique resource 520 displaying building information that is specific to the cover 500. In other words, in some embodiments, the at least two resources 520 display different building information. For example, a first data pattern linked to a first resource may be provided on a first cover located within a perimeter of a building. The first resource may display maintenance history related to the first cover. In another location within the perimeter the building, a second data pattern linked to a second resource may be provided on a second cover located within the perimeter of the building. The second resource may display maintenance history related to the second cover.

In some examples, it may be advantageous to store, in the database 540, a shared resource 520 displaying common building information. A worker may arrive at a building to perform maintenance on more than one cover 500 but may have no knowledge of how many covers 500 there are within the building. Further, even if the worker knows how many covers 500 there are, the worker may not know where the covers 500 are located. Thus, for example, a resource 520 linked to a cover 500, located near an entrance of the building, including a floor map displaying the locations of all the covers 500 within the perimeter of the building may help facilitate maintenance.

In some embodiments, the at least two resources 520 display identical building information for the at least two data patterns 510. For example, each of the at least two data patterns 510 may be provided on the at least two covers 500 located on the roof of a building, and the resource 520, to which the at least two data patterns 510 are both linked, may display a floor plan related to the roof of the building. Instead of providing multiple resources 520 displaying duplicated information, a single resource 520 displaying identical building information may be linked to the at least two data patterns 510 provided on the at least two covers 500.

In this way, a system of building information may be provided wherein resources 520 are grouped strategically to display building information based on a variety of factors, for example, the location of the covers 500 within a floor of a building, within the entire building, or within a set of buildings on a block.

The present invention has been described here by way of example only. Various modification and variations may be made to these exemplary embodiments without departing from the scope of the invention, which is limited only by the appended claims.

1. A cover for a drainage pipe comprising:
a machine-readable data pattern provided on the cover, wherein the machine-readable data pattern is linked to a resource displaying building information.

2. The cover of claim 1, wherein the machine-readable data pattern comprises a visual imprint.

3. The cover of claim 2, wherein the visual imprint comprises a quick response (QR) code, a barcode, and a universal product code.

4. The cover of claim 1, wherein the machine-readable data pattern is waterproof, weather-resistant, and UV-resistant.

5. The cover of claim 1, wherein the resource comprises a web page, a document, and an image.

6. The cover of claim 1, wherein the resource is editable.

7. The cover of claim 1, wherein the building information comprises a floor plan, a drainage system schematic, and maintenance history.

8. A building information system comprising:
a cover for a drainage pipe located within a perimeter of a building;
a machine-readable data pattern on the cover, wherein the machine-readable data pattern is linked to a resource displaying building information; and
a database for storing the resource, wherein the database provides the resource in response to the machine-readable data pattern being scanned.

9. The building information system of claim 8, wherein providing the resource comprises displaying the resource on a user device.

10. The building information system of claim 9, wherein the resource is a web page, a document, and an image.

11. The building information system of claim 8, wherein the resource is editable.

12. The building information system of claim 8, wherein the database is dynamically updated in response to the machine-readable data pattern being scanned.

13. The building information system of claim 12, wherein dynamically updating the database further comprises uploading an edit via a network.

14. The building information system of claim 13, wherein the edit comprises a text, an image, and a document.

15. The building information system of claim 12, wherein dynamically updating the database further comprises recording a time when the machine-readable data pattern is accessed.

16. The building information system of claim 8, wherein the machine-readable data pattern comprises a visual imprint.

17. The building information system of claim 16, wherein the visual imprint comprises a quick response (QR) code, a barcode, and a universal product code.

18. The building information system of claim 8 further comprising:
at least two covers located within the perimeter of the building, each having machine-readable data patterns; and
at least two resources displaying building information, each resource being linked to the machine-readable data patterns.

19. The Error! Reference source not found. of claim 18, wherein the at least two resources display different building information.

20. The Error! Reference source not found. of claim 18, wherein the at least two resources display identical building information.
